(19) United States
(12) Patent Application Publication
(10) Pub. No.: US 2010/0099075 A1
(43) Pub. Date: Apr. 22, 2010

(54) SEMEN MANIPULATION PROCESS

(76) Inventor: Cesar Augusto Ferraz Pedrazzi, Sorocaba (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/529,144

(22) PCT Filed: Jan. 22, 2008
(86) PCT No.: PCT/BR08/00018

§ 371 Date: Dec. 7, 2009

(30) Foreign Application Priority Data
Feb. 28, 2007 (BR) PI0700624-1

(51) Int. Cl. A01N 1/02

(52) U.S. Cl. 435/2

(57) ABSTRACT

The present invention refers to a semen manipulation process that aims at separating spermatic cells from their maintenance medium. The process the invention deals with allows for an increase in the final concentration of the obtained sperms and for an increase in the production indexes of in vitro embryos, presenting a great application in the assisted reproduction area of humans and animals overall. The invention describes a filtering system for the separation of spermatic cells from their maintenance medium characterized by the fact that it is made up by a filtering membrane that remains in contact with a primary plate placed on the heating plate and that also keeps the temperature constant throughout the process. The procedure includes filtering by using flush solutions and final maintenance solutions that are selected according to the later application of separated spermatic cells. Sperms withheld in the filtering membrane are resuspended and they may be used for artificial insemination, freezing, in vitro fecundation or sexying of the X and Y sperms in the flow cyto meter.

The present invention refers to a semen manipulation process aimed at separating spermatic cells from their maintenance medium. The process the invention deals with allows for an increase in the final concentration of the obtained sperms and an increase in the production indexes of in vitro embryos, thus presenting considerable application in the area of assisted reproduction in humans and animals overall.

### DESCRIPTION OF THE STATE OF THE ART

Separation processes of living sperms are used in clinical analysis laboratories in order, among other things, to separate feasible from non-feasible sperms, to separate the extender and/or seminal plasma from the sample, and to separate and purify the cellular components of the seminal plasma by removing scaling and contamination cells.

Among the processes most used to separate sperms, one might mention separation by centrifugation using Percoll. Percoll is a biologically inert fluid, made up of silica covered by colloidal particles that help in the centrifugation process by fostering separation and selection of the potentially fertile sperms based on the density difference among them. By submitting the seminal sample to a centrifugal force, Percoll particles scatter inside the tube, forming a density gradient and a consequent migration of more active sperms. Despite being routinely used in clinical analysis laboratories, this process presents some limitations, such as the fact that centrifugation itself causes cellular damage, recovers few cells and, as a result, makes harder to efficiently use high added-value samples.

There are also other separation methods by centrifugation with simple flushes, as well as ascending migration methods and sedimentation without centrifugation. Among these methods, the most known is the so-called “swim-up”. “Swim-up” is a traditional sedimentation-migration method based on the sperm's directional progression speed. The swim-up technique eliminates the seminal plasma, debris, amorphous material, exfoliative cells, sperms that are either dead, immovable or lacking directional progression speed. In the end, a clean sample is obtained with sperms that show excellent motility. The swim-up technique recovers about 20% of the movable sperms present in the initial ejaculation. The top advantage of swim-up is the recovery of high-quality cells, although the number of sperms is not so high, especially when the initial motility is low.

Recently, some criticism has been raised about the swim-up technique due to the detection of the presence of superoxide radicals in the sediments formed following centrifugations (Aitken and Clarkson, 1988). Such a fact, taking place before the migration process, would entail irreversible lesions to the sperms' plasmatic membranes, composed basically by phospholipids sensitive to the action of those oxidizing radicals, thus harming the future qualifying process. Fertilization problems with swim-up have been detected when work started with semen samples rich in abnormal or dead semen samples, debris, cellular remains, neutrophiles, macrophages, etc.

Also, according to Rheingantz, M. G. T. (Theriogenology, v.57, n. 1, p. 751, 2002), the manipulation of bovine semen using the swim-up technique favors the selection of a higher number of sperms holding the Y chromosome, leading to a deviation in the Male:Female ratio of the bovine embryos produced in vitro. This deviation may be considered a problem in bovine races with milking aptitude, as there is a great economic interest in producing females.

Among semen manipulation methods, we may also mention the Sephadex and Ficoll columns, which also have been used to eliminate immovable sperms, white cells or debris of the ejaculations, but with the inconvenience that a smaller number of sperms are recovered.

Document US2005/0032097 describes an isolation/separation method of sperms and spermatic DNA of non-spermatic cells in order to make possible to analyze the spermatic DNA of sexual violence victims. The first stage described in the technique includes the selective lysing of non-spermatic cells followed by vacuum filtration with membrane and resulting elimination of contaminants. However, this technique does not recover feasible sperms and in great quantity, as it uses chemical substances that also cause the lysing of non-spermatic cells in order to effect the separation of the sperms. During the lysing process, it is necessary to incubate the sample at high temperatures, approximately 56° C. for 30 minutes, which causes the spermatic motility to stop, lesions to the membrane, protein denaturing, chromosomal failures and spermatic death.

In document US2005/0112541, there is the description of an equipment made up of flow multicytometers used to classify particles according to one or more of their features, including sperm cells. Among the described applications, a concentration of sample sperms is shown following sexying by filtering in several stages, but results show a low sperm recovery and feasibility.

Document U.S. Pat. No. 5,185,246 proposes analysis methods of antispermatic antibodies, peroxidase enzyme, alkaline phosphatase enzyme and fructose tenor in semen, using, as initial common stage, separation by membrane of spermatic cells and seminal plasma. The procedure initially includes pre-dilution of the sample in phosphate buffer, followed by its filtering in hydrophilic synthetic membrane with an average pore diameter of 0.15-3 μm. However, said invention does not make references to the feasibility and motility of sperms separated with the use of the described technique, not even in regards to additional procedures used during filtering with the purpose of maintaining this feasibility and motility.

Results published by Martí, E. (Journal of Andrology, v., n., p. 2006) show a comparison between the separation methods of sperm cells using 4 distinct techniques (swim-up, centrifuging with Percoll, flushing with sucrose and filtering). The filtering process described by these authors was carried out through the initial dilution of twenty times the sample with specific buffer followed by vacuum filtering in Millipore-type membrane with a 5 μm pore diameter. Sperm cells were collected through the recovery of the last millimeter of sample presented in the filter surface. The filtering process resulted in less feasibility of sperm cells as compared with the swim-up and Percoll centrifuging methods. According to the authors, this smaller feasibility was the result of mechanical damages withstood by cells, possibly resulting from the use of vacuum and the repeated pipetting to which cells were submitted during the procedure.

### OBJECTIVES OF THE INVENTION

The present invention aims at providing a spermatic cell separation from its maintenance medium, whereupon sperms are obtained in higher total concentration with better quality, thus resulting, following fecundation, in higher blastocyte formation rates and, consequently, greater use of the genetic material used as raw material.

### BRIEF DESCRIPTION OF THE INVENTION

The objectives described in the invention referred to are achieved through the use of a filtering system to the separation of sperm cells from their maintenance medium, characterized by the fact that it is constituted by a filtering membrane that remains in contact with a primary plate placed over a heating plate and that keeps the temperature constant throughout the process. The procedure includes filtration using flush solutions and final maintenance solutions that are selected according to the later application of separated sperm cells. The sperms withheld in the filtering membrane are resuspended and they may be used for artificial insemination, freezing, in vitro fecundation or sexying of the X and Y sperms in the flow cytometer.

### DETAILED DESCRIPTION OF THE INVENTION

The present invention describes a filtering process of semen samples either in natura or already processed, which aims at separating sperm cells through the maintenance medium in which they are contained. The maintenance medium described in this invention refers to any medium in which sperm cells are held, including, among others, extenders and seminal plasma. The in natura semen is the semen collected from the donor animal that did not go through any processing, such as dilution, freezing, filtering or purification. The filtering process the invention deals with may be applied to filter the in natura semen or in natura semen that underwent some kind of processing. Among the several application possibilities of the respective invention, we may mention its use for i) Filtering the in natura semen or diluted in natura semen to be used in a) artificial insemination or b) in vitro fecundation or c) sexying of the X and Y sperms in the flow cytometer, or d) freezing; ii) Filtering in natura semen or diluted in natura semen that: a) was frozen and unfrozen; b) was sexed, frozen and unfrozen; with the goal of using it for in vitro fecundation or sexying of the X or Y sperms in flow cytometer, or artificial insemination.

The invention refers to a sperm cell separation process from its maintenance medium where initially the thermal stabilization of a semen sample, a flush medium solution and a final maintenance solution from 15° C. to 37° C. are made, the temperature being kept throughout the separation process. The maintenance medium described here may be constituted, among others, of seminal liquid, extenders used for maintaining the features of the semen during processing, or both.

The flush solution may be made up of solutions usually employed in in vitro fecundation techniques, including, among others:
TALP (Tyrode's Albumin Lactate Pyruvate) and its modifications, such as IVF-Talp, Fert-Talp, Hepes Talp, Clear-Talp (Sigma, Invitrogen, Gibco)
PBS saline buffer phosphate, DPBS Dulbecco's saline buffer Phospate, PBS (complete flush, Nutricell)
extender based on TRIS—Tris-hydroxymethyl amino-methane
Sodium citrate 2.9%
physiological saline 0.9%, Ringer or Lactate Ringer (JP)
Coconut water

The final maintenance solution usually consists of a solution used to maintain the characteristics of sperm cells during their transportation or processing (freezing, dilution, etc.), including, but not limited to:
Milk-based solution,
Yolk-based solution
Soybean lecithin-based solution
TRIS (Tris-hydro hydroxymethyl aminomethane) based solution
Freezing solution with glycerol or amines (example: dimethyl-formamines), or ethyl-glycol or propylene-glycol, or DMSO (Dimethyl-sulfoxide), or a mixture among them,
TALP (Tyrode's Albumin Lactate Pyruvate) and its modifications, such as: IVF-Talp, Fert-Talp, Hepes Talp, Clear-Talp (Sigma, Invitrogen, Gibco),
PBS Saline buffer phosphate, DPBS Dulbecco's saline buffer phosphate, PBS (complete flush, Nutricell)
Botu-Semen, Botu-Crio, Botu-Turbo, Botu-Bov (Biotech)
Bovmix, Equimix (Nutricell)
Maxsemen
Bioxcell CCS, Premix Oxyfree, INRA 96, EqcellFreeze, EqCell-sire (IMV-France)
Triladyl, Biladyl, ANDROHEP® (Minitube-Germany)

The separation process also includes thermal stabilization from 15° C. to 37° C. of a filtering container with a filtering membrane through the maintenance of the container and a membrane in direct contact with a primary plate located on a heating plate regulated in order to guarantee the stabilization temperature. The container and the membrane may also be in direct contact with the heating plate regulated in order to guarantee the stabilization temperature.

The membrane used has a pore diameter from 2 to 3 μm and, preferably, 3 μm. The membrane used is made up by materials compatible with the sperm work and it may, among others, be selected among Polyethersulfone (PES), Fluorite of Polyvinyldene (PVDF), Cellulose Ester (MCE), Polytetrafluoroethylene (PTFE), Nylon, Polypropylene (PP) and Polycarbonate. Preferably, the membrane used is made up by polycarbonate.

Preferably, the filtering container having the filtering membrane must be stabilized at the same temperature of the final maintenance solution, thus avoiding thermal shocks that might harm the sample with the sperms. The stabilization temperature of the filtering container and the filtering membrane is kept throughout the separation process. Initially, a flushing is carried out with the flush solution of the filtering membrane in the filtering container, and the filtering membrane is kept in direct contact with a primary plate on the heating plate stabilized at the same temperature of the final maintenance solution or in direct contact with the heating plate stabilized at the same temperature of the final maintenance solution. The primary plate must be made up by materials thermally compatible with the operation and may be made up, among other materials, by glass, plastic, paper, paper on glass or on plastic or paper directly placed on heating plate. The flushing is made by adding an appropriate flush solution under the filtering membrane in a sufficient amount in order to allow at least that the membrane be totally damped and that the flush solution goes through it. Following the flushing process of the filtering membrane, the semen sample is added to it and kept in direct contact with the primary plate placed on the heating plate or kept in direct contact with the heating plate stabilized at the same temperature of the final maintenance solution. The filtering of the semen sample is then carried out up to the moment when its amount on the filter reaches 0.5% to 20% of the initially added volume, and the filtering membrane is kept in direct contact with the primary plate on the heating plate or in direct contact with the heating plate stabilized at the same temperature of the final maintenance solution. During the process, a filtering by gravity is used, dispensing any other mean that aims at increasing the filtering speed, thus avoiding cells from suffering lesions. During this process, much of the cellular fragments, together with the maintenance solution, are separated from the sperm cells. Optionally, in order to remove possible residues in the sample, a flush of the sperm cells withheld in the filtering membrane is carried out through the addition of a flush solution on it and waiting until at least 90% to 95% of the added volume is filtered, while the membrane is kept in contact with the primary plate at the same temperature of the final maintenance solution or in direct contact with the heating plate stabilized at the same temperature of the final maintenance solution. The flushing process of the sperm cells may be repeated according to the sample conditions. After the flushing process of the filtering membrane with the flush solution, the sperm cells withheld in the filter are flushed with the final maintenance solution; meanwhile, it is necessary to wait that at least 90% to 95% of the added volume be filtered while keeping the contact of the membrane with the primary plate or with the heating plate at the same temperature of the final maintenance solution. In case one opts for not using the flush solution, the flushing of the cells withheld in the filtering membrane may be carried out only with the final maintenance solution. The flushing processes using flush solution or final maintenance solution may be repeated according to the sample conditions and according to the final application of the filtered cells. After carrying out the last flushing with the maintenance solution, the filtering container having the filtering membrane is separated from the contact with the primary plate or from the contact with the heating plate, and one adds to the filtering membrane the wanted volume of the maintenance solution that will serve as the new maintenance liquid of the sperm cells and that will naturally remain withheld in the filtering container. Resuspension of the cells withheld in the filter is made by stirring the solution using a glass stick or through suction and aspersion with a pipette. Also using a pipette, one transfers the re-suspended solution to a storing container kept at the same temperature of the final maintenance solution. The container with the filtered sperm sample may then be used in the several applications described in this report. Resuspension may be made as many times as necessary in order to lead to the total recovery of the cells that might be glued to the filter.

### Filtering of in Natura Semen or Diluted in Natura Semen

Filtering of in natura semen or diluted in natura semen has the function of separating sperms from their maintenance medium for later use of the semen in: artificial insemination, freezing, sexying of the X and Y sperms in the flow cytometer or in vitro fecundation. The removal of the maintenance medium of the in natura (ejaculated) semen or diluted in natura semen may also be followed by addition of freezing solution with the purpose of protecting the integrity of the sample during the freezing and unfreezing processes, which are used as techniques to improve spermatic characteristics. The removal of the maintenance medium is usually made by centrifugation of the ejaculated material at a specific rotation and time that may vary according to the origin of the sample. Often, some semen samples are more sensitive to centrifugation, with the occurrence of spermatic motility loss, lesion of the spermatic membrane, damages to the DNA and variation in the recovery of the sperms, causing losses from 15% to 30% and, for this reason, making worse the spermatic characteristics following unfreezing. Tests carried out with the semen of equines and bovines comparing centrifugation of the in natura semen with the filtration described by the present invention have shown that, for removing the sample maintenance medium, better results were achieved with the use of the filtration described by the invention. After freezing and unfreezing the semen samples of equines separated by the two methods, the samples that were initially separated by the filtering procedure described in this invention achieved the best results. According to the table 1, one notices that the samples separated by filtering presented, following unfreezing, 19% more total motility and 26% more progressive motility vis-à-vis those separated by centrifugation. Moreover, the samples that were filtered showed an improvement in the linear movement of the sperms. The comparison was made using analysis computerized by the CASA equipment (Hamilton THRON Research-IVOS 10).

TABLE 1

| | MT | MP |
|---|---|---|
| | Total motility | Progressive motility |
| | following unfreezing | following unfreezing |
| Conventional | 57% | 19% |
| centrifugation | | |
| New filtration process | 68% | 24% |

Comparative tests also were carried out for the separation of in natura bovine semen sperms sensitive to manipulation through separation by centrifugation and through filtration by the method of the present invention for later sexying in flow cytometer. The results showed best results for sperms separated through the procedure described in this invention; the sperms of some bulls did not resist centrifugation and, thus, their spermatic sexying was not possible.

Filtering of the in Natura Semen or Diluted in Natura Semen for In Vitro Fecundation or Sexying with Flow Cytomer Using Semen Sample that: a) was Frozen and Unfrozen, or b) was Sexied, Frozen and Unfrozen.

There are several techniques to prepare the semen for in vitro fecundation, including: centrifugation with flushing means or FIV (in vitro fecundation) means, swim-up, filtering with Sephadex columns and centrifugation with Percoll. The latter is the most used one.

Tests have been carried out comparing centrifugation with Percoll with filtering by the method of the present invention for removal of the freezing extender (e.g. egg yoke and glycerol, soy lecithin, milk) of the in natura semen that was frozen and unfrozen to be used in the in vitro fecundation.

The table 2 shows the result of the comparative tests between centrifugation with Percoll and the filtering described in the present invention for the removal of the extender (e.g. egg yoke and soy lecithin glycerol, milk) following unfreezing of the previously sexied X or Y semen to be used in in vitro fecundation. Results show a higher concentration of recovered sperms apt for fecundation of ovocytes upon the use of the filtering method described by the present invention. Moreover, the use of the filtering method described by the invention has resulted in an increase of about 15% in the number of embryos produced (D7 blastocytes) over those produced following centrifugation with Percoll. The production of embryos in D7 (blastocytes) is used to test the fecundation success, as they have already gone through the blockade of the embryonic genome, beginning of the cellular differentiation and have reached a satisfactory development stage that, when transferred to receptors, result in better gestation rates (40% average).

TABLE 2

| | | Spermatic | Spermatic | | | |
|---|---|---|---|---|---|---|
| | | concentration | concentration | | | |
| | Extender | before | following | Spermatic | | D7 blastocyte |
| | removal | extender removal | extender | feasibility | Cleavage | embryo |
| | method | (cel/ml) | removal (cel/ml) | (%) | rate (%) | rate (%) |
| A | Filter | 5.1 × 10⁶ | 2.9 × 10⁶ | 50 | 85 | 47 |
| A | Percoll | 5.1 × 10⁶ | 1.6 × 10⁶ | 60 | 81 | 32 |
| B | Filter | 2.1 × 10⁶ | 1.7 × 10⁶ | 50 | 82 | 49 |
| B | Percoll | 2.1 × 10⁶ | 4.0 × 10⁵ | 60 | 92 | 42 |
| C | Filter | 5.1 × 10⁶ | 3.1 × 10⁶ | 50 | 75 | 55 |
| C | Percoll | 5.1 × 10⁶ | 6.4 × 10⁵ | 50 | 61 | 46 |

As it can be seen by the results presented on the previous table, the use of the filtering process described in this invention has allowed, in all experiments, the obtainment of samples with a higher concentration of sperms that, after 7 days of cultivation, have presented an embryo rate (D7) or blastocytes clearly superior to the rate presented upon the removal of the extender with centrifugation using Percoll. The blastocyte formation rate is completed after seven days of cultivation, and it is one of the leading parameters to evaluate the fecundation success. The results shown on the previous table reinforce the importance of the improvement introduced in the fecundation process, allowing greater use of the semen and a higher success rate of the process.

Sexying of the frozen semen is a very advantageous technique, as it presents, besides other pluses, the possibility of a higher use of the genetic material of animals that have already died or that do not produce in natura semen to be sexied anymore. In this context and considering that the samples present a high added value, their higher yield and the success of the fecundation depend, in great measure, on the techniques used for sexying. The efficient removal of the extender used for freezing and, in consequence, the higher concentration of sperms by volume, is one of the requirements necessary to obtain a good sexying in flow cytometer. Sexying of the already frozen semen is of extreme interest, as it increases the use of the stored genetic material of animals that have been proven, established and that have high genetic value. There are several techniques to process the semen that has been frozen for future sexying, but they do not reach satisfactory results, as they need a high number of frozen doses to make a sample for sexying and also result in samples that show problems related to the removal of freezing extenders, leading to much spare extender residue and making difficult to separate X or Y sperms.

The table 3 shows the results of tests comparing the centrifugation using Percoll with filtering by the method of the present invention for the removal of the freezing extender (example egg yoke and glycerol, soy lecithin, milk) from the in natura bovine semen that was frozen and unfrozen to be used in the flow cytometer for sexying the sperms. As it can be seen, there was an increase in the number of recovered sperms. As it can be seen, there was an increase in the number of recovered sperms when compared to the centrifugation method with Percoll and, with this, a smaller number of frozen doses was used to make a sample. There was also an improvement in removing the extenders from the sample, which became purer, improving the processing in the flow cytometer. Sexying of the sperms that were previously manipulated through centrifugation using Percoll was not possible.

Comparative tests carried out in order to prove the in vitro fertility of the semen handled by filtration by the method of the present invention are shown at table 4:

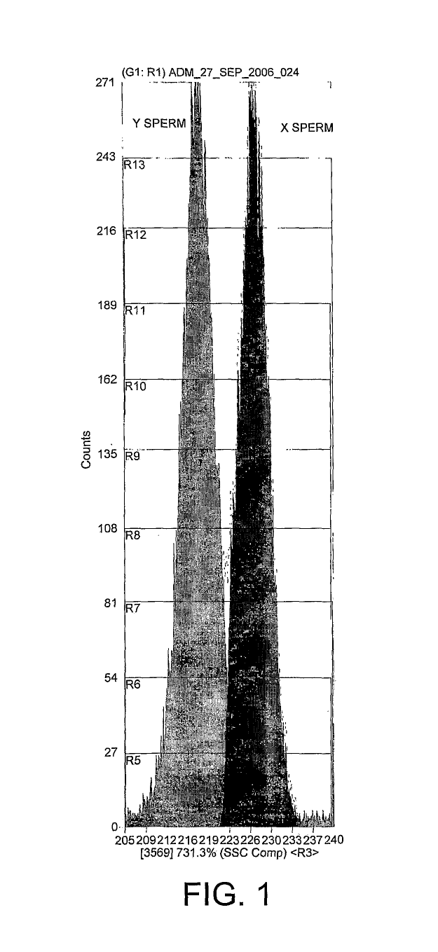

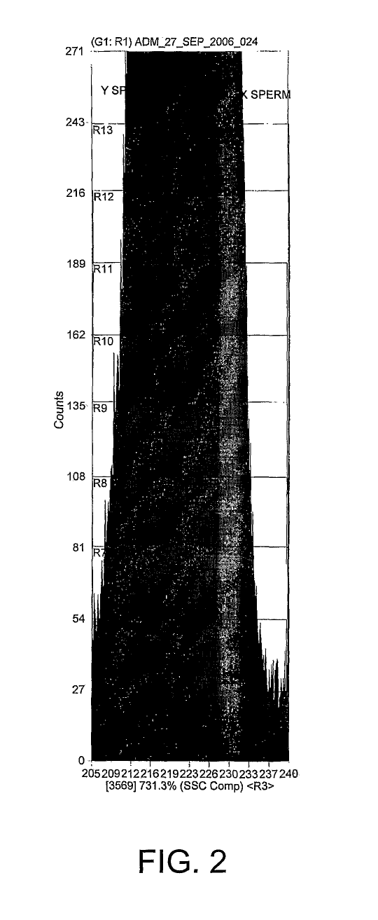

In order to prove the best results obtained upon the use of the filtering process described in the present invention, sperm cells separation histograms obtained during sexying by flow cytometer are shown in FIGS. 1 and 2. The flow cytometer used was model MoFlo, of the Dakocytomation brand. FIG. 1 shows the sperm cells separation histogram that was obtained following sexying by flow cytometer using unfrozen semen that, prior to sexying, was submitted to the removal of extenders through the filtering method of the present invention. The histogram clearly shows the formation of two distinct, uniform peaks, indicating that there was the separation of spermatic cells into two distinct populations with: Y (male chromosome cells, lighter left peak) and X (female chromosome cells, darker right peak). FIG. 2 shows the sperm cells separation histogram obtained during sexying by flow cytometer using unfrozen semen that, prior to sexying, was submitted to the removal of extenders through the centrifugation method with Percoll. The histogram shows the formation of a peak, indicating that it was not possible to carry out the separation of the spermatic cells into two distinct populations: X (female chromosome cells) and Y (male chromosome cells).

TABLE 3

| | | | Number of | | | | | |
|---|---|---|---|---|---|---|---|---|
| | Number | | initial | | | | Feasibility | |
| | of | Number | sperms | | Sexying | Number | following | Chromosome |
| | doses | of initial | following | Feasibility | by flow | of sexied | sexying | withholding |
| Method | used | sperms | treatment | (%) | cytometer | sperms | (%) | (%) |
| Filtering | 03 | 90 × 10⁶ | 84 × 10⁶ | 75 | Possible | 5 × 10⁶ | 80 | 89 |
| Percoll | 03 | 90 × 10⁶ | 6 × 10⁶ | 75 | It was not | — | — | — |
| | | | | | possible | | | |

TABLE 4

| | Bull | Oocytes | Cleavage | Embryo |
|---|---|---|---|---|
| Unfrozen semen | A | 100 | 75% | 40% |
| Unfrozen and sexied semen | A | 100 | 65% | 34% |
| Sexied semen | B | 100 | 67% | 36% |

The use of the filtering process described in the present invention contributes towards a better use in the selection employed in genetic improvement programs. The selection of the progeny sex in blocks may contribute towards a greater increase in the production system, directing future animals to the wanted sex.

1. Spermatic cell separation process from its maintenance medium characterized by the fact that it includes the following stages:
i) thermal stabilization of the semen sample, flush medium solution and final maintenance solution at a temperature from 15° C. to 37° C.;
ii) stabilization at a temperature from 15° C. to 37° of a filtering container with a filtering membrane through maintenance of the container and membrane in direct contact with the primary plate placed on the heating plate or in direct contact with the heating plate;
iii) flushing of the filtering membrane with flush solution keeping the filtering membrane in direct contact with the primary plate placed on the heating plate or in direct contact with the heating plate stabilized at the same temperature of the final maintenance solution;
iv) addition of the semen sample on the filtering membrane, keeping the filtering membrane in direct contact with the primary plate placed on the heating plate or in direct contact with the heating plate stabilized at the same temperature of the final maintenance solution.
v) filtering of the semen sample until its quantity reaches 0.5% to 20% of the added initial volume, and keeping the filtering membrane in direct contact with the primary plate placed on the heating plate or in direct contact with the heating plate stabilized at the same temperature of the final maintenance solution;
vi) optional addition of the flush solution on the filtering membrane waiting until at least 90% to 95% of the added volume be filtered by keeping the membrane in direct contact with the primary plate placed on the heating plate or in direct contact with the heating plate stabilized at the same temperature of the final maintenance solution;
vii) addition of final maintenance solution on the filtering membrane waiting that at least 90% to 95% of the added volume be filtered keeping the membrane in direct contact with the primary plate placed on the heating plate or in direct contact with the heating plate stabilized at the same temperature of the final maintenance solution;
viii) resuspension of the spermatic cells withheld in the filtering membrane through separation of the filtering container having the filtering membrane from contact with the primary plate or contact with the heating plate and flushing of the membrane with the final maintenance solution.

2. Separation process of the spermatic cells according to claim 1 characterized by the fact that the maintenance medium is made up by seminal liquid, extenders used for maintenance and extenders used to carry the semen.

3. Separation process of spermatic cells according to claim 1, characterized by the fact that the cell sample is made up by samples that were not frozen, as well as unfrozen samples.

4. Separation process of spermatic cells according to claim 1 characterized by the fact that on stage ii, the filtering membrane has a 2-to-3 μm porosity.

5. Separation process of spermatic cells according to claim 1 characterized by the fact that stage vi, is repeated more than once.

6. Separation process of spermatic cells according to claim 1 characterized by the fact that stage vii, is repeated more than once.

7. Separation process of spermatic cells according to claim 1 characterized by the fact that on stage viii, flushing is carried out a successive number of times.

8. Separation process of spermatic cells according to claim 1 characterized by the fact that on stage viii, re-suspended spermatic cells are stored in containers kept at a temperature from 15° C. to 37° C.

9. Separation process of spermatic cells according to claim 1 characterized by the fact that on stage viii, resuspension is carried out a number of times.
